(19) United States
(12) Patent Application Publication
(10) Pub. No.: US 2024/0388092 A1
(43) Pub. Date: Nov. 21, 2024

(54) CONTROL APPARATUS, CONTROL METHOD, AND NON-TRANSITORY COMPUTER READABLE MEDIUM

(71) Applicant: TOYOTA JIDOSHA KABUSHIKI KAISHA, Aichi-ken (JP)

(72) Inventor: Yusuke ONDA, Tokyo-to (JP)

(21) Appl. No.: 18/661,710

(22) Filed: May 13, 2024

(30) Foreign Application Priority Data
May 15, 2023 (JP) 2023-080399

(51) Int. Cl. H02J 3/28; H02J 13/00

(52) U.S. Cl. CPC H02J 3/28; H02J 13/00004; H02J 2300/24

(57) ABSTRACT

A control apparatus includes a controller configured to control a power storage facility to charge power at a first adjustment amount corresponding to a difference that occurs when planned electrical energy exceeds actual electrical energy, control a power generation facility to generate power at a second adjustment amount corresponding to a difference that occurs when the first adjustment amount exceeds electrical energy that the power storage facility has been controlled to charge, control the power generation facility to generate power at a third adjustment amount corresponding to a difference that occurs when the planned electrical energy is equal to or less than actual electrical energy, and control the power storage facility to discharge power at a fourth adjustment amount corresponding to a difference that occurs when the third adjustment amount exceeds electrical energy that the power generation facility has been controlled to generate.

### CROSS-REFERENCE TO RELATED APPLICATION

This application claims priority to Japanese Patent Application No. 2023-080399 filed on May 15, 2023, the entire contents of which are incorporated herein by reference.

### TECHNICAL FIELD

The present disclosure relates to a control apparatus, a control method, and a non-transitory computer readable medium.

### BACKGROUND

Technology related to adjusting electric power supply and demand is known. In order to stabilize electric power supply and demand, control to adjust the electric power supply and demand (hereinafter referred to as “balancing”) is performed so that the planned electrical energy which has been planned in advance and the actual electrical energy which has been actually supplied match. For example, Patent Literature (PTL) 1 discloses a technique related to control to make planned electrical energy and actual electrical energy substantially match.

### CITATION LIST

### Patent Literature

PTL 1: JP 2022-115359 A

### SUMMARY

There is room for improvement with respect to technology related to adjusting electric power supply and demand.

It would be helpful to improve technology related to adjusting electric power supply and demand.

A control apparatus according to an embodiment of the present disclosure is a control apparatus including a controller configured to transmit, to a power storage facility and a power generation facility, instructions to control each of the power storage facility and the power generation facility, the controller being configured to:
control the power storage facility to charge power at a first adjustment amount corresponding to a difference that occurs when planned electrical energy exceeds actual electrical energy;
control the power generation facility to generate power at a second adjustment amount corresponding to a difference that occurs when the first adjustment amount exceeds electrical energy that the power storage facility has been controlled to charge;
control the power generation facility to generate power at a third adjustment amount corresponding to a difference that occurs when the planned electrical energy is equal to or less than actual electrical energy; and
control the power storage facility to discharge power at a fourth adjustment amount corresponding to a difference that occurs when the third adjustment amount exceeds electrical energy that the power generation facility has been controlled to generate.

A control method according to an embodiment of the present disclosure is a control method executed by a control apparatus that transmits, to a power storage facility and a power generation facility, instructions to control each of the power storage facility and the power generation facility, the control method including:
calculating a difference between planned electrical energy and actual electrical energy;
controlling the power storage facility to charge power at a first adjustment amount corresponding to a difference that occurs when the planned electrical energy exceeds the actual electrical energy;
controlling the power generation facility to generate power at a second adjustment amount corresponding to a difference that occurs when the first adjustment amount exceeds electrical energy that the power storage facility has been controlled to charge;
controlling the power generation facility to generate power at a third adjustment amount corresponding to a difference that occurs when the planned electrical energy is equal to or less than actual electrical energy; and
controlling the power storage facility to discharge power at a fourth adjustment amount corresponding to a difference that occurs when the third adjustment amount exceeds electrical energy that the power generation facility has been controlled to generate.

A non-transitory computer readable medium according to an embodiment of the present disclosure stores a program configured to be executed by a control apparatus that transmits, to a power storage facility and a power generation facility, instructions to control each of the power storage facility and power generation facility, thereby causing the control apparatus to execute operations, the operations including:
calculating a difference between planned electrical energy and actual electrical energy;
controlling the power storage facility to charge power at a first adjustment amount corresponding to a difference that occurs when the planned electrical energy exceeds the actual electrical energy;
controlling the power generation facility to generate power at a second adjustment amount corresponding to a difference that occurs when the first adjustment amount exceeds electrical energy that the power storage facility has been controlled to charge;
controlling the power generation facility to generate power at a third adjustment amount corresponding to a difference that occurs when the planned electrical energy is equal to or less than actual electrical energy; and
controlling the power storage facility to discharge power at a fourth adjustment amount corresponding to a difference that occurs when the third adjustment amount exceeds electrical energy that the power generation facility has been controlled to generate.

According to an embodiment of the present disclosure, technology related to adjusting electric power supply and demand is improved.

### BRIEF DESCRIPTION OF THE DRAWINGS

In the accompanying drawings:

FIG. 1 is a block diagram illustrating an example of a schematic configuration of an electric power grid according to an embodiment;

FIG. 2 is a flowchart illustrating an example of operations of a control apparatus; and

FIG. 3 is a diagram illustrating an example of an adjustment method of electric power supply and demand.

### DETAILED DESCRIPTION

Hereinafter, an embodiment of the present disclosure will be described.

### Outline of Embodiment

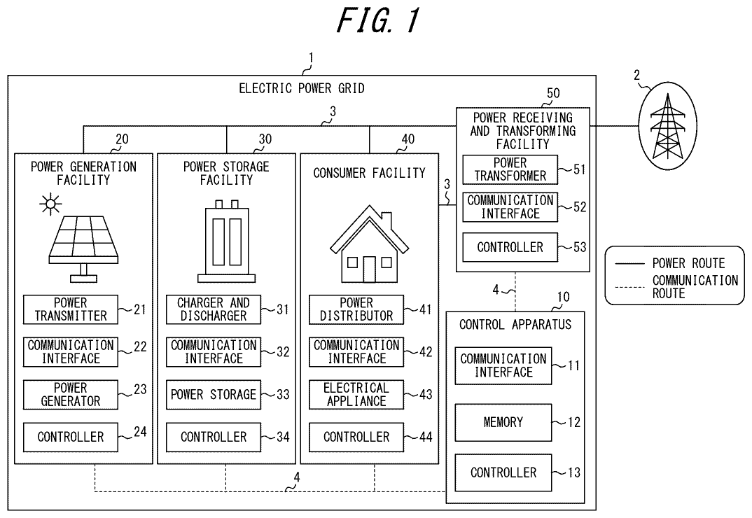

FIG. 1 is a block diagram illustrating an example of a schematic configuration of an electric power grid according to an embodiment. The electric power grid 1 includes a control apparatus 10, a power generation facility 20, a power storage facility 30, a consumer facility 40, and a power receiving and transforming facility 50. The power generation facility 20, the power storage facility 30, and the power receiving and transforming facility 50 are interconnected with the consumer facility 40 and the power receiving and transforming facility 50 by a power cable 3. The electric power grid 1 is supplied with electric power from a power company 2 through the power receiving and transforming facility 50. The control apparatus 10 is communicably connected to the power generation facility 20, the power storage facility 30, the consumer facility 40, and the power receiving and transforming facility 50 via a communication network 4.

The electric power grid 1 is, for example, a microgrid. The microgrid is a mechanism for local production and local consumption of energy by grouping energy supply sources and consumption facilities within a certain range. Distributed power sources such as photovoltaic or wind power are used as the source of energy. A microgrid stably adjusts the electric power supply and demand by installing the small-scale power generation facility 20 near electricity consumers and using distributed power sources.

The power company 2 supplies power to the electric power grid 1. The power company 2 enters into an electricity supply contract with a consumer of power in advance and supplies the consumer with planned electrical energy every predetermined period of time (e.g., monthly).

The control apparatus 10 is, for example, a computer such as a server apparatus. The control apparatus 10 is communicably connected to the power generation facility 20, the power storage facility 30, the consumer facility 40, and the power receiving and transforming facility 50 via the communication network 4.

Power generation facilities 20 are “distributed power sources” that convert renewable energy into electricity, for example, photovoltaic generators, thermal storage generators, or wind turbines. The power generation facility 20 is connected to the power storage facility 30 and the power receiving and transforming facility 50 by the power cable 3. In this disclosure, the power generation facility 20 includes a thermal storage facility that converts heat stored in a thermal storage tank into electricity to generate power of thermal energy storage. The power generation facility 20 transmits the generated electricity to the power storage facility 30 or the power receiving and transforming facility 50 via the power cable 3. The power generation facility 20 is communicably connected to the control apparatus 10 via the communication network 4.

The power storage facility 30 is a storage battery that stores electricity supplied by the power company 2 or electricity generated by the power generation facility 20 and discharges the stored electricity. The power storage facility 30 charges electricity transmitted from the power receiving and transforming facility 50 or the power generation facility 20 via the power cable 3 and discharges the charged electricity to the power receiving and transforming facility 50. The power storage facility 30 is communicably connected to the control apparatus 10 via the communication network 4.

The consumer facilities 40 are buildings, condominiums, public facilities (e.g., schools), stores, or residences, and are equipped with electrical appliances that consume power, such as air conditioning equipment and lighting fixtures. The consumer facilities 40 receive power distribution from the power receiving and transforming facilities 50 via the power cables 3. The consumer facility 40 is communicably connected to the control apparatus 10 via the communication network 4.

The power receiving and transforming facilities 50 accept high-voltage electricity supplies distributed from the power company 2, transform them, and distribute them to various devices within the area of the electric power grid 1. The power receiving and transforming facilities 50 distribute electricity that the power storage facilities 30 are controlled to charge. The power receiving and transforming facilities 50 convert electricity to a voltage that can be used by the consumer facilities 40 and distribute electricity to the consumer facilities 40. The power receiving and transforming facility 50 is communicably connected to the control apparatus 10 via the communication network 4.

The control apparatus 10 of the present embodiment controls the power storage facility 30 to charge power at a first adjustment amount corresponding to a difference that occurs when planned electrical energy exceeds actual electrical energy, control the power generation facility 20 to generate power at a second adjustment amount corresponding to a difference that occurs when the first adjustment amount exceeds electrical energy that the power storage facility 30 has been controlled to charge, control the power generation facility 20 to generate power at a third adjustment amount corresponding to a difference that occurs when the planned electrical energy is equal to or less than the actual electrical energy, and control the power storage facility 30 to discharge power at a fourth adjustment amount corresponding to a difference that occurs when the third adjustment amount exceeds electrical energy that the power generation facility 20 has been controlled to generate.

Thus, according to the present embodiment, charging of the power storage facility 30 is prioritized in order to adjust electric power supply and demand. Therefore, even in a situation where discharge from the power storage facility 30 is required, the power generation facility 20 is first required to generate power within its generating capacity, and if the power supply and demand still cannot be adjusted, the power storage facility 30 is required to discharge the power. Therefore, the technology for adjusting power supply and demand is improved in that the probability of adjusting power supply and demand even when the output of major power sources, such as solar power generators, plummets is increased.

### (Control Apparatus Configuration)

The control apparatus 10 includes a communication interface 11, a memory 12, and a controller 13.

The communication interface 11 includes at least one interface for communication for connecting to the communication network 4. The communication interface is compliant with a wired local area network (LAN) standard, or a wireless LAN standard, for example, but not limited to these, and may be compliant with any communication standard. In the present embodiment, the control apparatus 10 communicates with the power generation facility 20, the power storage facility 30, the consumer facility 40, and the power receiving and transforming facility 50 via the communication interface 11 and the communication network 4.

The memory 12 includes one or more memories. The memories are semiconductor memories, magnetic memories, optical memories, or the like, for example, but are not limited to these. The memories included in the memory 12 may each function as, for example, a main memory, an auxiliary memory, or a cache memory. The memory 12 stores any information used for operations of the control apparatus 10. For example, the memory 12 may store a system program, an application program, embedded software, planned electrical energy for which the power company 2 has contracted with a consumer and the like. The information stored in the memory 12 may be updated with, for example, information acquired from the communication network 4 via the communication interface 11.

The controller 13 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 13 controls operations of the entire control apparatus 10.

The controller 13 retrieves the planned electrical energy from the memory 12. The controller 13 routinely receives, via the communication interface 11 and the communication network 4, the electrical energy generated by the power generation facility 20, the electrical energy charged and discharged by the power storage facility 30, the electrical energy consumed by the consumer facility 40 (an electrical appliance 43), and the actual electrical energy supplied by the power receiving and transforming facility 50 from the power company 2. The controller 13 calculates the first, second, third, fourth, and fifth adjustment amounts described below based on the various electrical energy values received. The controller 13 transmits the first through the fifth adjustment amounts to the power generation facility 20, the power storage facility 30, the consumer facility 40, and the power receiving and transforming facility 50 via the communication interface 11 and the communication network 4.

### (Composition of Power Generation Facility)

The power generation facility 20 includes a power transmitter 21, a communication interface 22, a power generator 23, and a controller 24. The power generation facilities 20 are “distributed power sources” installed within the area of the electric power grid (microgrid) 1.

The power transmitter 21 transmits the electricity generated by the power generator 23 to the power receiving and transforming facility 50 or the power storage facility 30 via the power cable 3.

The communication interface 22 includes at least one interface for communication for connecting to the communication network 4. The communication interface is compliant with a wired local area network (LAN) standard, or a wireless LAN standard, for example, but not limited to these, and may be compliant with any communication standard. In the present embodiment, the power generation facility 20 communicates with the control apparatus 10 via the communication interface 22 and the communication network 4.

The power generator 23 can be, but is not limited to, a photovoltaic generator, wind turbine generator, or thermal storage generator. The power generator 23 generates power based on instructions from the control apparatus 10 via the communication interface 22 and the communication network 4.

The controller 24 includes at least one processor, at least one programmable circuit, at least one dedicated circuit, or a combination of these. The controller 24 controls operations of the entire power generation facility 20. The controller 24 controls the power generator 23 to set the power adjustment amount (also referred to as the first adjustment amount, the second adjustment amount, or the third adjustment amount in the operation flow of the control apparatus 10 described below) notified by the control apparatus 10 to the target value and to control the power generator 23 to generate power. The controller 24 routinely notifies the control apparatus 10 of the electrical energy generated by the power generator 23 via the communication interface 22 and the communication network 4.

### (Composition of Power Storage Facility)

The power storage facility 30 includes a charger and discharger 31, a communication interface 32, a power storage 33, and a controller 34.

The charger and discharger 31 receives electricity to be stored in the power storage 33, which is transmitted from the power receiving and transforming facility 50 or the power generation facility 20, via the power cable 3, or transmits electricity discharged by the power storage 33 in the power storage facility 30 to the power receiving and transforming facility 50 via the power cable 3.

The communication interface 32 includes at least one interface for communication for connecting to the communication network 4. The communication interface is compliant with a wired local area network (LAN) standard, or a wireless LAN standard, for example, but not limited to these, and may be compliant with any communication standard. In the present embodiment, the power storage facility 30 communicates with the control apparatus 10 via the communication interface 32 and the communication network 4.

The power storages 33 are stationary storage batteries, but are not limited to these. The power storage 33 may be a battery electric vehicle (BEV) or a plug-in hybrid electric vehicle (PHEV) battery (in-vehicle storage battery). The power storage 33 charges or discharges power based on instructions from the control apparatus 10 via the communication interface 32 and the communication network 4.

The controller 34 includes at least one processor, at least one programmable circuit, at least one dedicated circuit, or a combination of these. The controller 24 controls operations of the entire power storage facility 30. The controller 34 controls the power storage 33 to charge or discharge power by setting the adjustment amount directed by the control apparatus 10 to the target value. The controller 34 routinely notifies the control apparatus 10 of the electrical energy that the power storage 33 is charging via the communication interface 32 and the communication network 4.

### (Composition of Consumer Facility)

The consumer facility 40 includes a power distributor 41, a communication interface 42, the electrical appliance 43, and a controller 44. The consumer facilities 40 are buildings, apartments, stores, or residences, or public facilities (e.g., schools), etc., owned or leased by customers located in the area of the electric power grid (microgrid) 1. The consumer facilities 40 are equipped with electrical appliances that consume power, such as air conditioning equipment, lighting fixtures, or freezers and refrigerators.

The power distributor 41 receives power distribution from the power receiving and transforming facilities 50 via the power cables 3 and steps down the distributed voltage (e.g., from 200 VAC to 100 VAC). The power distributor 41 includes, but is not limited to, a switchboard and a distribution board that distributes power lines from the switchboard to multiple electrical appliances.

The communication interface 42 includes at least one interface for communication for connecting to the communication network 4. The communication interface is compliant with a wired local area network (LAN) standard, or a wireless LAN standard, for example, but not limited to these, and may be compliant with any communication standard. In the present embodiment, the consumer facility 40 communicates with the control apparatus 10 via the communication interface 42 and the communication network 4.

The electrical appliances 43 are loads that consume power, including but not limited to air conditioning units, lighting fixtures, and freezers/refrigerators.

The controller 44 includes at least one processor, at least one programmable circuit, at least one dedicated circuit, or a combination of these. The controller 44 controls operations of the entire consumer facility 40. The controller 44 is the home controller. The controller 44 controls the electrical appliance 43 to promote or suppress the power consumption of the electrical appliance 43 by setting the power adjustment amount (also referred to as the fourth adjustment amount in the operation flow of the control apparatus 10 described below) directed by the control apparatus 10 to the target value. The controller 44 routinely notifies the control apparatus 10 of the electrical energy consumed by the electrical appliance 43 via the communication interface 42 and the communication network 4.

### (Configuration of Power Receiving and Transforming Facilities)

The power receiving and transforming facility 50 includes a power transformer 51, a communication interface 52, and a controller 53. The power receiving and transforming facilities 50 serve as the entrance (gate) for the power company 2 to transmit (sell) the planned electrical energy to the electric power grid (microgrid) 1. The power receiving and transforming facilities 50 receive high-voltage electricity from the power company 2, transform it (step-down), and distribute it to the power generation facilities 20, the power storage facilities 30, and the consumer facilities 40 connected by the power cables 3 in the area of the electric power grid 1.

The power transformer 51 receives the actual electrical energy supply from the power company 2. The power transformer 51 steps down the high-voltage electricity supplied by the power company 2 and distributes it to the power generation facilities 20, the power storage facilities 30, and the consumer facilities 40 connected by the power cable 3 within the area of the electric power grid 1.

The communication interface 52 includes at least one interface for communication for connecting to the communication network 4. The communication interface is compliant with a wired local area network (LAN) standard, or a wireless LAN standard, for example, but not limited to these, and may be compliant with any communication standard. In the present embodiment, the power receiving and transforming facility 50 communicates with the control apparatus 10 via the communication interface 52 and the communication network 4. The communication interface 52 routinely notifies the control apparatus 10 of the state of electricity supply and demand in the area of the electric power grid 1.

The controller 53 includes at least one processor, at least one programmable circuit, at least one dedicated circuit, or a combination of these. The controller 53 controls operations of the entire power receiving and transforming facility 50. The controller 53 routinely notifies the control apparatus 10 of the actual electrical energy supplied by the power company 2 via the communication interface 52 and the communication network 4. The controller 53 controls the actual electrical energy supplied by the power company 2 to be supplied to equipment within the area of the electric power grid 1, and furthermore, if there is a surplus electrical energy, it is charged to the power storage facility 30 via the power transformer 51.

### (Flow of Operations of Control Apparatus)

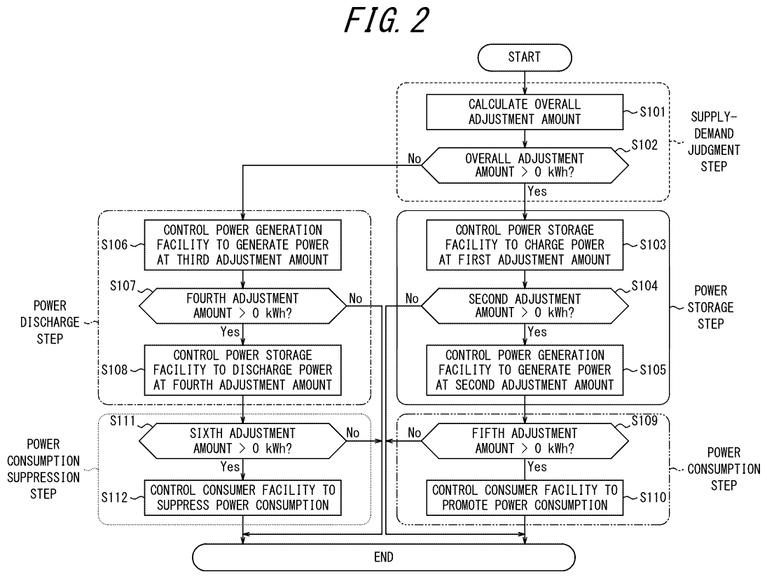

FIG. 2 is a flowchart illustrating an example of operations of the control apparatus 10. This operation relates to the coordination of power supply and demand within the area of the electric power grid 1 by the control apparatus 10.

In steps S101-S102, the controller 13 calculates the overall adjustment amount W₀, which is the difference between the planned electrical energy Wₚₗₐₙ and the actual electrical energy W_{act}, and performs a supply-demand judgment step to determine whether the overall adjustment amount W₀ exceeds 0 kWh.

Step S101: The controller 13 calculates the overall adjustment W₀ by subtracting the actual electrical energy W_{act} from the planned electrical energy Wₚₗₐₙ.

The planned electrical energy Wₚₗₐₙ is the amount of electrical energy supplied to the electric power grid 1 within a given period (e.g., monthly) based on the power supply plan (contract) between the consumer and the power company 2. The actual electrical energy W_{act} is the electrical energy actually supplied to the electric power grid 1 from the power company 2. The overall adjustment amount W₀ is the difference between the planned electrical energy Wₚₗₐₙ and the actual electrical energy W_{act}, and is obtained by the following formula (1). The controller 13 acquires the planned electrical energy Wₚₗₐₙ from the memory 12. The controller 13 acquires the actual electrical energy W_{act} from the power receiving and transforming facility 50 via the communication interface 11 and the communication network 4. The units for the planned electrical energy Wₚₗₐₙ, actual electrical energy W_{act}, and overall adjustment W₀ are kWh.

$${W}_{0} = {W}_{plan} - {W}_{a c t} \qquad ( 1 )$$

Step S102: The controller 13 determines whether the overall adjustment W₀ is greater than 0 kWh. If the overall adjustment W₀ is greater than 0 kWh, proceed to step S103; if the overall adjustment W₀ is equal to or less than 0 kWh, proceed to step S106.

If the overall adjustment W₀ is greater than 0 kWh, a further supply of electrical energy from the power company 2 is expected.

In steps S103 to S105, the controller 13 performs the power storage step to control the power storage facility 30 to charge power at the first adjustment amount W₁ corresponding to the difference that occurs when the planned electrical energy Wₚₗₐₙ exceeds the actual electrical energy W_{act}, and to control the power generation facility 20 to generate power at the second adjustment amount W₂ corresponding to the difference that occurs when the first adjustment amount W₁ exceeds the electrical energy that the power storage facility 30 has been controlled to charge. For convenience, the overall adjustment amount W₀ when the overall adjustment amount W₀ is greater than 0 kWh is referred to as the first adjustment amount W₁, and the overall adjustment amount W₀ when the overall adjustment amount W₀ is less than 0 kWh is referred to as the third adjustment amount W₃.

Step S103: If the first adjustment amount W₁ is 0 kWh or more, the controller 13 sets the first adjustment amount W₁ to the target value and controls the power storage facility 30 to charge power.

The controller 13 sets the first adjustment amount W₁ to the target value and controls the power storage facility 30 to charge the power.

If the first adjustment amount W₁ exceeds 0 kWh, the controller 13 controls the power storage facility 30 to charge the power within the power storage capacity of the power storage facility 30 by setting the first adjustment amount W₁ to the target value.

Step S104: The controller 13 determines whether the second adjustment amount W₂, which is the first adjustment amount W₁ minus the electrical energy that the power storage facility 30 has been controlled to charge, exceeds 0 kWh. If the second adjustment amount W₂ is greater than 0 kWh, proceed to step S105; if the second adjustment amount W₂ is equal to or less than 0 kWh, the process ends.

The second adjustment amount W₂ is the difference between the first adjustment amount W₁ and the electrical energy What that the power storage facility 30 has been controlled to charge, and is obtained by the following formula (2). The controller 13 acquires electrical energy W_{bat} from the power storage facility 30 via the communication interface 11 and the communication network 4. The unit of the electrical energy W_{bat} and the second adjustment amount W₂ is kWh.

$${W}_{2} = {W}_{1} - {W}_{b a t} \qquad ( 2 )$$

If the second adjustment amount W₂ is 0 kWh or a negative value, the controller 13 terminates the process without controlling the power generation facility 20 to generate power. This is because there is no electrical energy that allows the power generation facility 20 to generate power on the electric power grid 1.

Step S105: When the second adjustment amount W₂ exceeds 0 kWh, the controller 13 sets the second adjustment amount W₂ to the target value and controls the power generation facility 20 to generate power.

If the second adjustment amount W₂ is greater than 0 kWh, the controller 13 sets the second adjustment amount W₂ to the target value and controls the power generation facility 20 to generate power within the power generation capacity of the power generation facility 20. In this disclosure, the power generation facility 20 shall include a thermal storage facility that converts heat stored in a thermal storage tank into electricity to generate power of thermal energy storage.

In steps S106 to S108, the controller 13 performs a power discharge step in which the controller 13 controls the power generation facility 20 to generate power at the third adjustment amount W₃ corresponding to the difference that occurs when the planned electrical energy Wₚₗₐₙ is equal to or less than the actual electrical energy W_{act} and controls the power storage facility to discharge power at the fourth adjustment amount W₄ corresponding to the difference that occurs when the third adjustment amount W₃ exceeds the electrical energy that the power generation facility 20 has been controlled to generate.

Step S106: The controller 13 sets the absolute value of the third adjustment amount W₃ to the target value and controls the power generation facility 20 to generate power.

If the overall adjustment W₀ is equal to or less than 0 kWh, no further supply of electrical energy is expected from the power company 2. In such cases, discharge from the power storage facility 30 is generally required to adjust the power supply and demand. However, in the present disclosure, the controller 13 controls the power generation facility 20 to set the absolute value of the third adjustment amount W₃ to the target value and to generate power within the power generation capacity of the power generation facility 20 before controlling the power storage facility 30 to discharge the power. The “absolute value” of the third adjustment amount W₃ is stated here because the value of the third adjustment amount W₃ is negative. The controller 13 controls the power generation facility 20 to generate power to make up for the shortfall in the power supply.

Step S107: The controller 13 determines whether the fourth adjustment amount W₄, which is the absolute value of the third adjustment amount W₃ minus the absolute value of the electrical energy that the power generation facility 20 has been controlled to generate, exceeds 0 kWh. If the fourth adjustment amount W₄ is greater than 0 kWh, proceed to step S108; if the fourth adjustment amount W₄ is equal to or less than 0 kWh, the process ends.

The fourth adjustment amount W₄ is the difference of the absolute value of the third adjustment amount |W₃| minus the absolute value of the electrical energy generated by the power generation facility 20, |W_{gen}|, and is obtained by the following formula (3). The controller 13 acquires electrical energy W_{gen} from the power generation facility 20 via the communication interface 11 and the communication network 4. The unit of the electrical energy W_{gen} and the fourth adjustment amount W₄ is kWh.

$${W}_{4} = \vert {W}_{3} \vert - \vert {W}_{gen} \vert \qquad ( 3 )$$

If the fourth adjustment amount W₄ is 0 kWh or a negative value, the controller 13 terminates the process without controlling the power storage facility 30 to discharge power. This is because the shortfall in power supply in the electric power grid 1 was compensated for by power generation.

Step S108: When the fourth adjustment amount W₄ exceeds 0 kWh, the controller 13 sets the fourth adjustment amount W₄ to the target value and controls the power storage facility 30 to discharge power.

As described above, the controller 13 sets the absolute value of the third adjustment amount W₃ to the target value and controls the power generation facility 20 to generate power within the power generation capacity of the power generation facility 20 before controlling the power storage facility 30 discharge the power from the power storage facility 30. However, if the fourth adjustment amount W₄ exceeds 0 kWh, that is, if the power supply is still insufficient even though the power generation facility 20 has generated power, the controller 13 controls the power storage facility 30 to discharge the power by setting the fourth adjustment amount W₄, which corresponds to the shortfall, to the target value.

In step S109 to step S110, the controller 13 performs a power consumption step in which the controller 13 controls the consumer facility 40 to consume power at the fifth adjustment amount W₅ corresponding to the difference that occurs when the second adjustment amount W₂ exceeds the electrical energy that the power generation facility 20 has been controlled to generate.

Step S109: After executing the power storage step, the controller 13 determines whether the fifth adjustment amount W₅, which is the second adjustment amount W₂ minus the electrical energy W_{gen} that the power generation facility 20 has been controlled to generate, exceeds 0 kWh.

The fifth adjustment amount W₅ is the difference between the second adjustment amount W₂ and the electrical energy W_{gen} that the power generation facility 20 has been controlled to generate, and is obtained by the following formula (4). The unit for the fifth adjustment amount W₅ is kWh.

$${W}_{5} = {W}_{2} - {W}_{gen} \qquad ( 4 )$$

If the fifth adjustment amount W₅ is 0 kWh or a negative value, the controller 13 terminates the process without controlling the consumer facilities 40 to promote power consumption. This is because there is no electrical energy that controls the consumer facilities 40 to consume power on the electric power grid 1.

Step S110: When the fifth adjustment amount W₅ exceeds 0 kWh, the controller 13 sets the fifth adjustment amount W₅ to the target value and controls the consumer facilities 40 to promote the power consumption.

The state in which the fifth adjustment amount W₅ exceeds 0 kWh is a state in which there is still room for power supply even after controlling the power storage facility 30 to store power within power storage capacity and controlling the power generation facility 20 to generate power within power generation capacity. Therefore, the controller 13 adjusts the power supply and demand by controlling the consumer facilities 40 to promote the operation of air conditioning equipment or lighting fixtures, etc.

In step S111 to step S112, the controller 13 performs the power consumption suppression step to control the consumer facility 40 to suppress power consumption at the sixth adjustment amount W₆ corresponding to the difference that occurs when the fourth adjustment amount W₄ exceeds the electrical energy that the power storage facility 30 has been controlled to discharge power.

Step S111: After executing the power discharge step, the controller 13 determines whether the sixth adjustment amount W₆, which is the absolute value of the third adjustment amount W₃ minus the absolute value of the electrical energy W_{dis} that the power storage facility 30 has been controlled to discharge, exceeds 0 kWh.

The sixth adjustment amount W₆ is the difference between the absolute value of the third adjustment amount W₃, |W₃|, and the absolute value of the electrical energy W_{dis}, |W_{dis}|, that the power storage facility 30 has been controlled to discharge, and is obtained by the following formula (5). The controller 13 acquires the amount of electrical energy W_{dis} from the power storage facility 30 via the communication interface 11 and the communication network 4. The unit of the electrical energy W_{dis} and the sixth adjustment amount W₆ is kWh.

$${W}_{6} = \vert {W}_{3} \vert - \vert {W}_{dis} \vert \qquad ( 5 )$$

If the sixth adjustment amount W₆ is 0 kWh or a negative value, the controller 13 terminates the process without controlling the consumer facilities 40 to suppress power consumption. This is because the shortfall in power supply in the electric power grid 1 was compensated for by power generation and power discharge.

Step S112: When the sixth adjustment amount W₆ exceeds 0 kWh, the controller 13 sets the sixth adjustment amount W₆ to the target value and controls the consumer facility 40 to suppress power consumption.

When the sixth adjustment amount W₆ exceeds 0 kWh, the power supply is still insufficient even if the power generation facility 20 is controlled to generate power within power generation capacity and the power storage facility 30 is controlled to discharge power within power storage capacity. Therefore, the controller 13 adjusts the power supply and demand by controlling the consumer facility 40 to suppress the operation of air conditioning equipment, lighting fixtures, and other equipment.

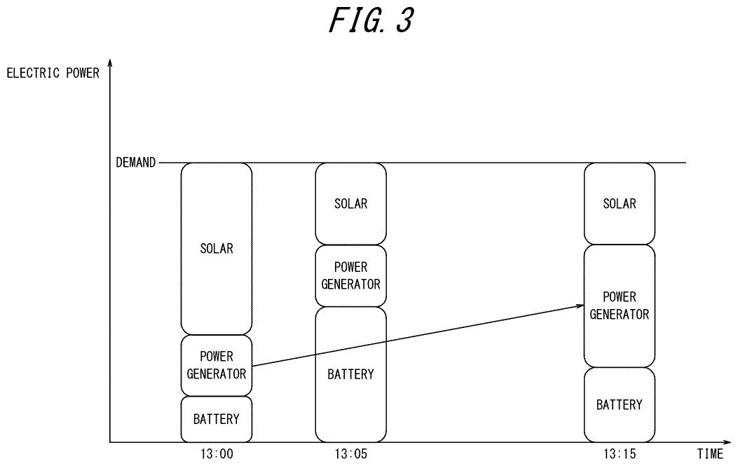

When introducing power generated by photovoltaic generators into the electric power grid 1, if the output of a photovoltaic generator suddenly drops due to changes in weather conditions, it may take time for other generators in the area of the electric power grid 1 to complete start-up and interconnection, which may not fully compensate for the sudden drop in output of the photovoltaic generator. For example, when the weather is clear during the day, the output of a photovoltaic generator is high, but when cumulonimbus clouds cover the sun, the output plummets. In such a case, as illustrated in FIG. 3, for example, if another generator is turned on at 13:00, the grid connection takes place at 13:15, during which time about 15 minutes are spent. Therefore, if the output of a photovoltaic generator plummets, the power generated cannot be immediately compensated by other generators. At that time, if the power storage capacity of the power storage battery is 0 kWh, discharge from the power storage battery cannot be performed, resulting in a discrepancy between power supply and demand. For this reason, it is desirable to constantly recharge the power storage batteries in case of a sudden drop in the output of the solar generator, but if the power storage batteries are dedicated to recharging, the regulating capacity of the power storage batteries cannot be used during the recharging process.

In this respect, the control apparatus 10 of the present embodiment controls the power storage facility 30 to charge power at the first adjustment amount W₁ corresponding to the difference that occurs when the planned electrical energy Wₚₗₐₙ exceeds the actual electrical energy W_{act}, controls the power generation facility 20 to generate power at the second adjustment amount W₂ corresponding to the difference that occurs when the first adjustment amount W₁ exceeds the electrical energy that the power storage facility 30 has been controlled to charge, controls the power generation facility 20 to generate power at the third adjustment amount W₃ corresponding to the difference that occurs when the planned electrical energy Wₚₗₐₙ is equal to or less than the actual electrical energy W_{act}, and controls the power storage facility 30 to discharge power at the fourth adjustment amount W₄ corresponding to the difference that occurs when the third adjustment amount W₃ exceeds the electrical energy that the power generation facility 20 has been controlled to generate. In this way, charging the power storage facility 30, i.e., power storage, is prioritized in order to adjust the power supply and demand. Therefore, even in a situation where discharge from the power storage facility 30 is required, the probability of adjusting power supply and demand even when the output of the main power source, such as a solar power generator, suddenly drops is improved by first controlling the power generation facility 20 to generate power and then controlling the power storage facility 30 to discharge the power when power supply and demand still cannot be adjusted. Thus, technology related to adjusting electric power supply and demand is improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the control apparatus 10 in the above embodiment are distributed to multiple computers capable of communicating with each other can be implemented. For example, an embodiment in which some or all of the components of the control apparatus 10 are provided in the power generation facility 20, the power storage facility 30, or the consumer facility 40 can also be implemented.

For example, an embodiment in which a general purpose computer functions as the control apparatus 10 according to the above embodiment can also be implemented. Specifically, a program in which processes for realizing the functions of the control apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A control apparatus comprising a controller configured to transmit, to a power storage facility and a power generation facility, instructions to control each of the power storage facility and the power generation facility, the controller being configured to:
control the power storage facility to charge power at a first adjustment amount corresponding to a difference that occurs when planned electrical energy exceeds actual electrical energy;
control the power generation facility to generate power at a second adjustment amount corresponding to a difference that occurs when the first adjustment amount exceeds electrical energy that the power storage facility has been controlled to charge;
control the power generation facility to generate power at a third adjustment amount corresponding to a difference that occurs when the planned electrical energy is equal to or less than actual electrical energy; and
control the power storage facility to discharge power at a fourth adjustment amount corresponding to a difference that occurs when the third adjustment amount exceeds electrical energy that the power generation facility has been controlled to generate.

2. The control apparatus according to claim 1, wherein the controller is further configured to:
control a consumer facility to consume power at a fifth adjustment amount corresponding to a difference that occurs when the second adjustment amount exceeds the electrical energy that the power generation facility has been controlled to generate; and
control the consumer facility to suppress power consumption at a sixth adjustment amount corresponding a difference that occurs when the fourth adjustment amount exceeds electrical energy that the power storage facility has been controlled to discharge.

3. The control apparatus according to claim 1, wherein the power generation facility includes a thermal storage facility that converts heat stored in a thermal storage tank into electricity to generate power of thermal energy storage.

4. A control method executed by a control apparatus that transmits, to a power storage facility and a power generation facility, instructions to control each of the power storage facility and the power generation facility, the control method comprising:
calculating a difference between planned electrical energy and actual electrical energy;
controlling the power storage facility to charge power at a first adjustment amount corresponding to a difference that occurs when the planned electrical energy exceeds the actual electrical energy;
controlling the power generation facility to generate power at a second adjustment amount corresponding to a difference that occurs when the first adjustment amount exceeds electrical energy that the power storage facility has been controlled to charge;
controlling the power generation facility to generate power at a third adjustment amount corresponding to a difference that occurs when the planned electrical energy is equal to or less than actual electrical energy; and
controlling the power storage facility to discharge power at a fourth adjustment amount corresponding to a difference that occurs when the third adjustment amount exceeds electrical energy that the power generation facility has been controlled to generate.

5. A non-transitory computer readable medium storing a program configured to be executed by a control apparatus that transmits, to a power storage facility and a power generation facility, instructions to control each of the power storage facility and power generation facility, thereby causing the control apparatus to execute operations, the operations comprising:
calculating a difference between planned electrical energy and actual electrical energy;
controlling the power storage facility to charge power at a first adjustment amount corresponding to a difference that occurs when the planned electrical energy exceeds the actual electrical energy;
controlling the power generation facility to generate power at a second adjustment amount corresponding to a difference that occurs when the first adjustment amount exceeds electrical energy that the power storage facility has been controlled to charge;
controlling the power generation facility to generate power at a third adjustment amount corresponding to a difference that occurs when the planned electrical energy is equal to or less than actual electrical energy; and
controlling the power storage facility to discharge power at a fourth adjustment amount corresponding to a difference that occurs when the third adjustment amount exceeds electrical energy that the power generation facility has been controlled to generate.
